(19) United States
(12) Patent Application Publication
(10) Pub. No.: US 2011/0256414 A1
(43) Pub. Date: Oct. 20, 2011

(54) METHOD FOR COATING A FIBER COMPOSITE COMPONENT FOR AN AIRCRAFT OR SPACECRAFT AND FIBER COMPOSITE COMPONENT PRODUCED BY SAID METHOD

(76) Inventors: Peter Knepper, Ganderkesee (DE); Klaus J. Eisenmenger, Quickborn-Heide (DE)

(21) Appl. No.: 13/152,371

(22) Filed: Jun. 3, 2011

Related U.S. Application Data
(62) Division of application No. 12/910,270, filed on Oct. 22, 2010.

(30) Foreign Application Priority Data
Apr. 30, 2008 (DE) 10 2008 001 468
Mar. 12, 2009 (EP) PCT/EP2009/052902

(51) Int. Cl. B32B 15/04

(52) U.S. Cl. 428/457

(57) ABSTRACT

In a method for coating a fibre composite component for an aircraft or spacecraft, a surface layer of the fibre composite component, which surface layer has spacing from the fibres introduced in the fibre composite component for the protection thereof, is pretreated, at least in portions to form a primer coat; at least one functional coat is then applied to the formed primer coat. A corresponding fibre composite component comprises at least one functional coat which is applied to a primer coat.

### CROSS-REFERENCE TO RELATED APPLICATIONS

This application is a divisional of pending U.S. patent application Ser. No. 12/910,270 filed Oct. 22, 2010 and claims the benefit of U.S. Provisional Application No. 61/126,003, filed Apr. 30, 2008 and German Patent Application No. 10 2008 001 468.0, filed Apr. 30, 2008, the entire disclosures of which are herein incorporated by reference.

### FIELD OF THE INVENTION

The present invention relates to a method for coating a fibre composite component for an aircraft or spacecraft and to a fibre composite component produced by a method of this type.

Up until now, metals which are highly distinctive in terms of the mechanical and technological properties thereof and the long-term behaviour thereof during the service life of an aircraft are still predominantly used for structural components in aircraft construction. However, these metals do not optimally meet the current requirements for weight optimisations. Therefore, various other composite materials have been developed and optimised in such a way that they meet the conventional high safety requirements in aviation when lightweight construction principles are consistently applied. Glass fibre plastics materials and, in particular, carbon fibre-reinforced plastics materials are used for this purpose.

Although the present invention and the problem on which it is based can be applied to any fibre composite components, in the following they will be described in detail with reference to carbon fibre plastics material components (also termed fibre composite components), for example the fuselage, wings or rudder unit of an aircraft.

Fibre composite components are widely used in aircraft construction. They are produced, for example, by vacuum infusion processes for introducing a matrix, for example an epoxy resin, into fibre semi-finished products and by subsequent curing. Compared to other known processes for the production of fibre composite components, for example the prepreg process, infusion processes can be cost-efficient as they allow the use of more economical fibre semi-finished products.

However, besides high strength combined with low weight, fibre composite materials also have insufficient surface properties. In particular, low resistance to wear and erosion and lack of electrical conductivity can be mentioned as examples in this case.

All operational areas in an aircraft or spacecraft may require complete or partial modifications to the surface of the composite materials or composite components.

Currently, metals or metal cloth, for example, are adhesively bonded to or laminated into fibre-reinforced materials to modify the surface properties thereof. Different methods, for example adhesive bonding, sometimes bolting or riveting of metals, insulating materials or insulating layers are also used. However, it is difficult to achieve a mixture of property modifications.

In the case of metals, requirements of this type are met in a variety of ways by a large range of thermal spraying processes. In principle, this technique can also be transferred to the coating of fibre composite components. To prepare the surface to be coated, blasting thereof is conventionally used.

DE 100 37 212 A1 describes plastics material surfaces, including fibre-reinforced plastics material surfaces, having a thermally sprayed coating, an adherend surface initially being applied by means of a thermal spraying process and a functional coating being applied thereon, also by means of a thermal spraying process. A method for coating sports equipment, in particular golf clubs, is given.

DE 10 2005 008 487 A1 describes a coated body, in particular a roller, made of carbon fibre reinforced plastics material and a method for producing a body of this type. A roller of this type, in particular for paper machines and printing machines, is coated with an adhesion-promoting coat and then with a wear-resistant coat by means of a thermal spraying process.

DE 197 47 384 A1 describes a production of composite bodies with coating by thermal spraying, for example for a gas-tight and vacuum-tight coating of a ceramic pipe.

The above-mentioned publications make no reference to safety requirements for the coating of fibre composite components for aircraft or spacecraft. In this context, there is also no mention of the risk of damage to the fibres, which is not particularly relevant to bodies of this type, but is to aeronautical structural components, for example.

### SUMMARY OF THE INVENTION

Against this backdrop, the object of the present invention is to provide a method for coating a fibre composite component for an aircraft or spacecraft and a corresponding fibre composite component, in order to eliminate or considerably reduce the above-mentioned drawbacks.

A method for coating a fibre composite component for an aircraft or spacecraft is provided which has the following method steps. First, an adhesive coat is formed by pretreating a surface layer of the fibre composite component at least in portions. The surface layer in which the primer coat is formed is spaced from the fibres introduced in the fibre composite component for the protection thereof. At least one functional coat is subsequently applied to the primer coat formed.

Furthermore, a fibre composite component having at least one functional coat is produced. The at least one functional coat is applied to a primer coat which is formed by pretreatment, at least in portions, of a surface layer of the fibre composite component, which surface layer has spacing from the fibres introduced in the fibre composite component for the protection thereof.

An idea forming the basis for the invention is that a surface layer of the fibre composite component, which surface layer has spacing from the fibres introduced in the fibre composite component for the protection thereof, is pretreated, at least in portions, to form a primer coat for the application of at least one functional coat. There is to be no contact between the fibres and the primer coat which is applied or formed.

In this way, the present invention has, inter alia, the advantage over the approaches mentioned in the introduction that damage to the fibres of the fibre composite component is avoided, a requirement for weight optimisation being met at the same time.

Types of coating can be produced which are capable of improving the fibre composite components across a range of materials, in such a way that a larger field of application of fibre composite components in aircraft construction can be made possible. In particular, the following properties, and also combinations thereof, can be made possible, for example protection against wear, protection against erosion, electrical conductivity, shielding against electromagnetic radiation, heat insulation, resistance to chemical influences, electrical insulation.

Furthermore, surfaces constructed in a defined manner can be produced, for example nanostructures and/or simulated fish skin surfaces.

Advantageous embodiments and improvements of the present invention are provided in the subclaims.

In the pretreatment, impurities and grease of any kind can be removed. In addition, chemical processes, laser beam machining, cold radiation or other suitable techniques can be used.

In the pretreatment, the primer coat can be produced with a surface topography having a roughened surface. As a result, the adherend surface is increased. The surface topography can be formed with cavities having undercuts. This is possible for example by means of laser beam treatment, it being possible for spherical bubbles, for example in the region of one tenth, to form in the coat, which bubbles burst and thus produce undercuts.

In a further embodiment, the primer coat is formed by applying at least one resin/adhesive coat during the step of pretreating the surface layer. In this way, the thickness of the surface layer can be increased if necessary. For example, the resin/adhesive coat can be applied as a thin coat. Consequently, it is also possible to form thicker primer coats or a plurality of primer coats one on top of another, causing no damage to the fibres. All resins or adhesives are suitable, provided that the curing mechanisms thereof meet the requirements for the subsequent application of a functional coat and the component requirements.

The resin/adhesive coat can comprise a resin/adhesive substance having particles which are mixed into the resin/adhesive substance prior to the application of the resin/adhesive coat. The particles can also be applied and bonded to the resin/adhesive coat after the application thereof. For example, it is possible to sprinkle the particles onto the resin/adhesive coat applied in this way. The particles are then bonded to the resin/adhesive coat by the adhesive properties of the resin/adhesive coat, it also being possible, for example, for the particles to be worked or pressed into the resin/adhesive coat. A combination of premixed resin/adhesive substance with particles and subsequently applied particles is also possible.

Any kind of resin and/or adhesive is suitable. Partial or complete curing is carried out as necessary for the degree of cure to meet the requirements of a subsequent spraying and the component requirements. All materials which can be obtained as a powder (metals, ceramic, oxides, carbides, etc.) can be used as mixing materials. This procedure is characterised by the particularly simple technology thereof, which results in a very economical and cost-effective solution.

In another embodiment, it is preferred that the pretreatment effects an application of individual particles to form a primer coat which is closed at least in portions. As a result, the adherend surface is increased and the adhesion of a functional coat which is to be applied is improved. It is particularly preferred that the individual particles are applied by means of a thermal spraying process. All materials which are suitable for thermal spraying (for example, metals, ceramic, oxides, carbides, thermoplastic polymers, etc.) can be used as particulate materials. By way of example, a range for the particle size can be from 1 to 100 μm, but it may also be possible to use nanoparticles.

The thermal spraying process can be a high-speed flame spraying.

Together with the primer coat, the surface layer pretreated in this way forms a base on which any desired functional coat can be applied. Spraying processes and materials which correspond to the prior art can also be used in this case. In this way it is possible, for example, to improve to the following functions: sound insulation, protection against wear, protection against corrosion, emergency running properties, rolling resistance, material application, electrical conductivity, heat insulation, electrical insulation, etc.

The component made of fibre-reinforced material can be completely or partially coated with the desired functional coat. In addition, any thermal spraying processes can be used in principle.

In a further embodiment, the at least one functional coat can comprise embedded components. These can be, for example, strip conductors and/or fibres for various purposes. The components can also be introduced with a corresponding cover which can protect them from damage during spraying. Further systems and components which can be integrated are, for example, heating systems, glass fibres, testing components (also for online evaluation).

A fibre composite component is produced as described above.

For all coatings, only one process technology can be used, namely thermal spraying. This results in excellent bond strength of the coatings on the fibre composite component. Various properties and also a combination of properties of the functional coats can be produced by mixed or graduated coats. Coats can be applied in succession for this purpose. It is likewise possible to spray on mixed powder.

### BRIEF DESCRIPTION OF THE DRAWINGS

In the following, the invention is described in detail on the basis of embodiments with reference to the following figures of the drawings.

In the figures:

FIG. 1 is a schematic sectional view at right angles to fibres of a fibre composite component according to the present invention which is shown by way of example to illustrate a pretreatment of a surface layer;

FIG. 2 is a further schematic sectional view at right angles to fibres of a fibre composite component according to the present invention which is shown by way of example to illustrate a further pretreatment of a surface layer; and

FIG. 3 is a schematic sectional view at right angles to fibres of a coated fibre composite component according to the present invention which is shown by way of example.

### DESCRIPTION OF EXEMPLARY EMBODIMENTS

In the figures, like reference numerals denote like or functionally identical components, unless indicated otherwise.

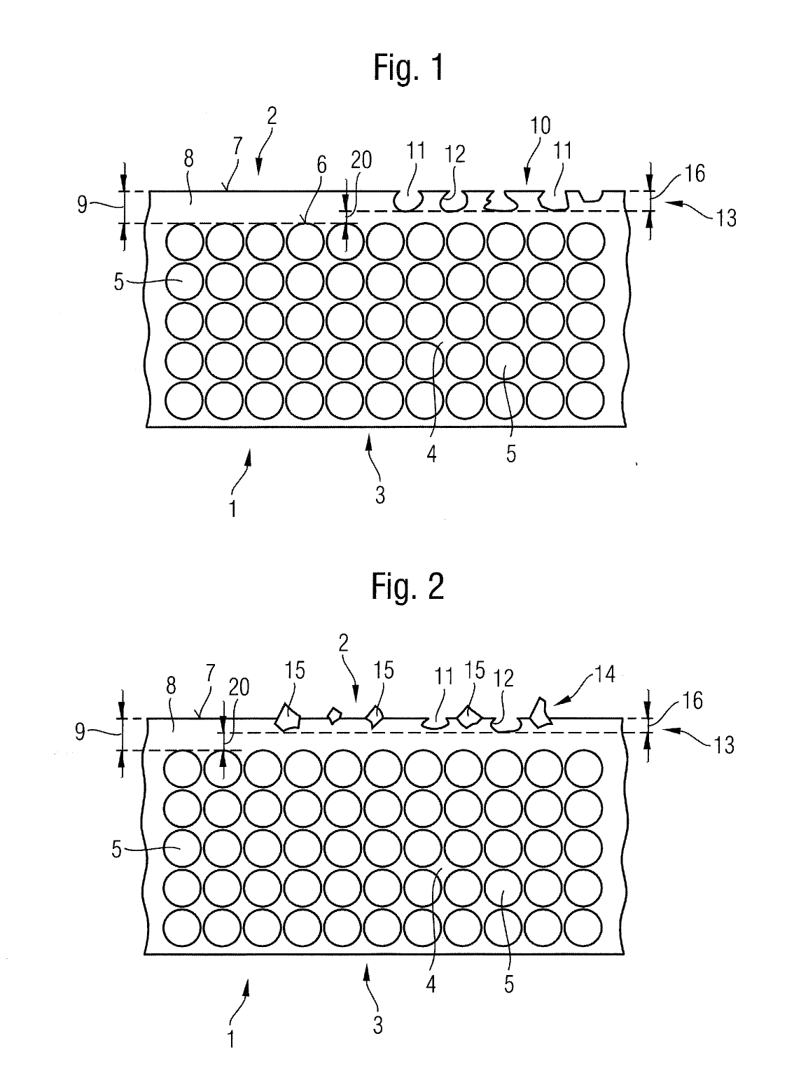

FIG. 1 is a schematic sectional view at right angles to fibres 5 of a fibre composite component 1 according to the present invention which is shown by way of example to illustrate a pretreatment of a surface layer 8.

The fibre composite component 1 comprises fibres 5 embedded in a matrix 4, for example made of a resin, and in this example is in a cured state. At the bottom of the figure, the resin forms a lower face 3 with a top coat under the fibres 5 and at the top of the figure an upper face 2 with a top coat over the fibres 5.

In the example the top coat of the upper face 2 comprises a surface layer 8 with a surface 7 and a surface layer thickness 9. In this case, the surface layer thickness 9 is understood to mean the measurement from the surface 7 to a fibre surface 6 which has the smallest spacing from the surface 7.

The left-hand side of the fibre composite component 1 shows the surface 7 which is to be coated in order to protect the fibre composite component 1 against wear. In addition, if impurities and grease have not yet been removed from the surface 7 of the surface layer 8, these are removed therefrom in a first method step.

This is followed by a further pretreatment of the surface layer 8, whereby a primer coat 13 with a surface topography 10 is produced using a suitable method, for example laser beam machining. During this, the surface layer 8 is roughened, cavities 11 with undercuts 12 having formed in this example, for example by bubbles bursting. Of course, other mechanical or chemical processes are possible.

In this case, it is important that the primer coat 13 is formed in the surface layer 8 within a given penetration depth 16. The penetration depth 16 is a measurement from the surface 7 up to a given spacing 20 from the fibre surface 6 which has the smallest distance from the surface 7. In this way it is ensured that no fibres 5 are damaged by the pretreatment process.

FIG. 2 is a further schematic sectional view at right angles to fibres 5 of the fibre composite component 1 according to the present invention which is shown by way of example to illustrate a further pretreatment of the surface layer 8. In this case, an alternative way of forming a primer coat 13 by applying particles 15 in the surface layer 8 as a particle coat 14 is shown. During this, as described above, it is important that the penetration depth 16 is not exceeded. The particles 15 are applied, for example, by means of a thermal spraying process. A high bond strength of the particles 15 in the surface layer 8 is thereby achieved.

It is also possible to combine the particle coat 14, which does not have to be closed in the region of the surface 7, with the cavities 11 having undercuts 12 described with reference to FIG. 1.

In this way, the surface 7 is increased by the pretreatment, a primer coat 13 forming on which, in a further method step, a further coating is applied, thereby achieving excellent adhesion to the fibre composite component 1, without fibres 5 being damaged.

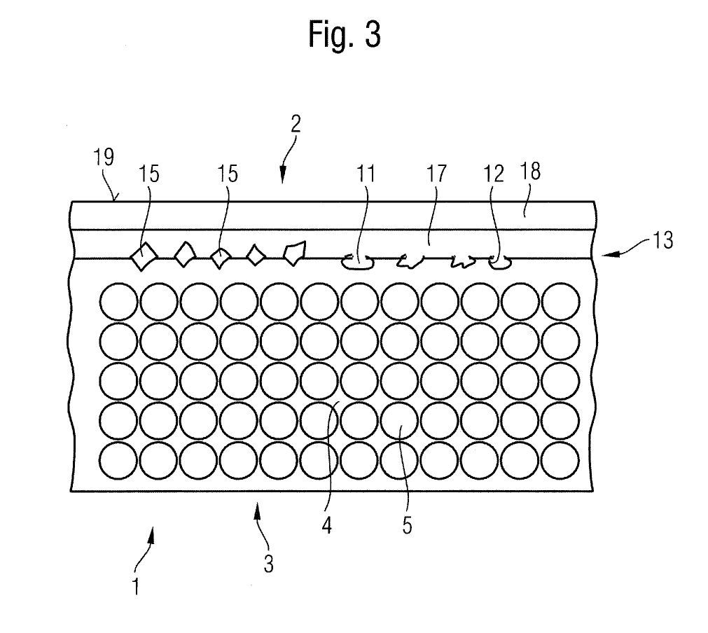

FIG. 3 is a schematic sectional view at right angles to fibres 5 of a coated fibre composite component 1 according to the present invention which is shown by way of example.

A first functional coat 17 and, on top of this, a second functional coat 18 are applied to the primer coat 13, which shows an example with particles 15 in the left-hand region of the figure and an example with cavities 11 and undercuts 12 in the right-hand region of the figure. The application is also carried out by means of a thermal spraying process.

The second functional coat 18 forms an outer surface 19 of the coated fibre composite component 1. The first functional coat 17 can be, for example, a metallic coat, it being possible for the second functional coat 18 to be a corrosion-resistant coat or an insulating coat. The second functional coat 18 can also form a structured outer surface 19 having nanostructures. A large number of different combinations are possible.

Although the present invention has presently been described on the basis of preferred embodiments, it is not restricted thereto, but can be modified in many different ways.

For example, the pretreatment of the surface layer 8 can effect roughening of the surface layer 8, no undercuts 12 being formed.

Strip conductors for heating systems, for example, can also be integrated, into the functional coats 17, 18.

The functional coats 17, 18 can also serve as metal coats for electromagnetic shielding and/or as a lightning protection and/or as protection against impacts or knocks.

The top coat, which is shown in FIG. 1 as a surface layer 8 with a surface layer thickness 9 (shown oversized), can also be made to this measurement by applying additional resin/adhesive coats, for example in order to obtain a sufficient spacing 20 from the penetration depth 16. An elevation of this kind of the surface layer 8 by an additional resin/adhesive coat can be carried out, for example, by means of two variants for the production of a primer coat 13 in this way. On the one hand, particles are firstly mixed into a resin/adhesive substance and subsequently applied to the surface layer 8 as a thin coat. On the other hand, the resin/adhesive substance is applied to the surface layer 8 as a thin coat and then particles are sprinkled thereon and optionally worked or pressed onto or into the resin/adhesive substance. All types of resin and/or adhesive are suitable. In both cases, the resin/adhesive coat formed is partially or completely cured, as necessary for the degree of cure to meet the requirements of the subsequent spraying of further coats, for example the functional coats 17, 18, and the component requirements. All materials which can be obtained as a powder (metals, ceramic, oxides, carbides, etc.) can be used. Evidently, it is possible to combine the above-described further pretreatments of this resin/adhesive coat to form surface topographies and/or further coatings with like, similar and/or different particles of other and/or like dimensions.

In a method for coating a fibre composite component 1 for an aircraft or spacecraft, pretreatment of a surface layer 8 of the fibre composite component 1, which surface layer has spacing from the fibres 3 introduced in the fibre composite component 1 for the protection thereof, is carried out at least in portions to form a primer coat 13; at least one functional coat 17, 18 is then applied to the formed primer coat 13. A corresponding fibre composite component 1 comprises at least one functional coat 17, 18, which is applied to a primer coat 13.

### LIST OF REFERENCE NUMERALS

1 fibre composite component
2 upper face
3 lower face
4 matrix
5 fibre
6 fibre surface
7 surface
8 surface layer
9 surface layer thickness
10 surface layer topography
11 cavity
12 undercut
13 primer coat
14 particle coat
15 particle
16 penetration depth
17 first functional coat
18 second functional coat
19 outer surface
20 spacing

1. A fibre composite component comprising at least one functional coat which is applied to a primer coat which is formed by pretreatment, at least in portions, of a surface layer of the fibre composite component, which surface layer has spacing from the fibres introduced in the fibre composite component for the protection thereof, individual particles being applied to form a primer coat which is closed at least in portions, the at least one functional coat being formed as a metal coat formed of metal particles for lightning protection.

2. The fibre composite component according to claim 1, wherein the at least one functional coat comprises embedded components.

3. The fibre composite part according to claim 2, wherein the embedded components comprise strip conductors and/or fibres.
